(19) United States
(12) Patent Application Publication
(10) Pub. No.: US 2017/0068896 A1
(43) Pub. Date: Mar. 9, 2017

(54) SPECIALISATION MECHANISM FOR TERMINOLOGY REASONING

(71) Applicant: Agfa HealthCare NV, Mortsel (BE)

(72) Inventors: Jos DE ROO, Mortsel (BE); Giovanni MELS, Mortsel (BE); Hong SUN, Mortsel (BE); Dirk COLAERT, Mortsel (BE)

(73) Assignee: AGFA Healthcare NV, Mortsel (BE)

(21) Appl. No.: 15/120,165

(22) PCT Filed: Mar. 2, 2015
(86) PCT No.: PCT/EP2015/054296

§ 371 Date: Aug. 19, 2016

(30) Foreign Application Priority Data
Mar. 3, 2014 (EP) 14157487.1

(51) Int. Cl. G06N 5/04; G06F 17/30

(52) U.S. Cl. CPC G06N 5/04; G06F 17/30979

(57) ABSTRACT

A method for generating rules for rule-based reasoning includes the steps of starting from a set of generic reasoning rules generating a set of specific reasoning rules by substituting in at least one of the generic reasoning rules having more than one variable, at least one of the variables with (a) class(es) defined in an ontology.

### CROSS-REFERENCE TO RELATED APPLICATIONS

This application is a 371 National Stage Application of PCT/EP2015/054296, filed Mar. 2, 2015. This application claims the benefit of European Application No. 14157487.1, filed Mar. 3, 2014, which is incorporated by reference herein in its entirety.

### BACKGROUND OF THE INVENTION

1. Field of the Invention

The present invention relates to a rule-based reasoning method.

2. Description of the Related Art

Clinical decision support is a technique to help physicians with decision making tasks, such as obtaining a diagnosis for a patient.

Clinical decision support systems generally execute queries on large data repositories of patient data. Clinical terminology is used in such queries in expressing the domain of interest. The success of retrieving the desired results is largely depending on understanding the used terminology, as well as its hierarchy.

Terminology reasoning is thus required in executing such queries. Executing queries on a data repository by means of state of the art rule based reasoning techniques may take a large amount of computational effort, which might be unacceptable.

It is thus an aspect of the present invention to provide a technique that results in a decrease of computational effort required to solve such a query by transforming the rule set that is used for querying.

The present invention has been developed with the aim of optimizing the querying of data repositories of clinical patient information in a healthcare environment. The field of application of the present invention is however not limited thereto.

### SUMMARY OF THE INVENTION

The above-mentioned aspect is realized by a method as set out below.

Specific features for preferred embodiments of the invention are also set out below.

According to the present invention rules used in rule based reasoning are so-called ‘specialized’. In this context ‘specialisation of a rule’ is defined as described below.

Consider a general rule

∀x, y : P(x) [symbol] Q(x, y) [symbol] C(x, y)

And consider an ontology containing statements P(a).

This rule can be specialized for each value “a” of x as follows:

$$\frac{∀ x , y \text{:} P ( x ) ⇒ ( Q ( x , y ) ⇒ C ( x , y ) ) P ( a )}{∀ y \text{:} Q ( a , y ) ⇒ C ( a , y )}$$

The rules ∀ y : Q(a,y) [symbol] C(a,y) are defined in the context of the present invention as specialized rules, in which the value of x is “materialized”.

As a result of the above described specialization the statements P(a) and the rule ∀x,y : P(x) [symbol] Q(x,y) [symbol] C(x,y) can be eliminated from the knowledge base.

The present invention is applicable to rules comprising at least two variables.

It is important that the number of variables in the “P( ) part” is one lower than the total number of variables in the rule. That way, after the variables in the P( ) part are substituted with constant terms from the ontology, one variable remains unbound.

Also, not all variables in P must occur in Q( ) or C( ).

$$\frac{∀ x , y , z \text{:} P ( x , z ) ⇒ ( Q ( x , y , z ) ⇒ C ( x , y , z ) ) P ( a , b )}{∀ y : Q ( a , y , b ) ⇒ C ( a , y , b )}$$

The rdfs:subClassOf rule (used in the embodiment described below) is an example of rule which contains 3 variables.

Specialisation according to the present invention differs from materialisation which operation is defined below (this materialization is not aimed at in the present invention).

Consider a rule

∀x : P(x) [symbol] C(x)

And consider an ontology containing statements P(a).

The ontology can be materialized using Modus Ponens:

$$\frac{∀ x \text{:} P ( x ) ⇒ C ( x ) P ( a )}{C ( a )}$$

The statements C(a) are added to the ontology.

The rule ∀x : P(x) [symbol] C(x) can be eliminated from the ontology.

The rule specialisation method of the present invention is advantageous in that the computation speed of the terminology reasoning can be enhanced using specialised rules obtained by applying reasoning on generic rules as set out higher.

The set of specialised rules can be computed in advance of querying a data repository and only needs to be adapted in case the ontology would change.

The set of specialised rules can be compiled into an image, which is a binary, reasoner specific representation of a rule set. This representation is advantageous since the reasoner can load this binary representation much faster than a textual form of the rules.

The method of the present invention is generally implemented in the form of a computer program product adapted to carry out the method steps of the present invention when run on a computer. The computer program product is commonly stored in a computer readable carrier medium such as a DVD. Alternatively the computer program product takes the form of an electric signal and can be communicated to a user through electronic communication.

Further advantages and embodiments of the present invention will become apparent from the following description and drawing.

### BRIEF DESCRIPTION OF THE DRAWINGS

FIG. 1 is a schematic representation of an ontology describing bone fractures.

### DETAILED DESCRIPTION OF THE PREFERRED EMBODIMENTS

While the present invention will hereinafter be described in connection with preferred embodiments thereof, it will be understood that it is not intended to limit the invention to those embodiments.

The invention will be explained with regard to an application in the field of querying a repository of clinical data but is not limited to this application. The invention can be used in other applications based on rule-based reasoning as well as on data representing other types of information than clinical information.

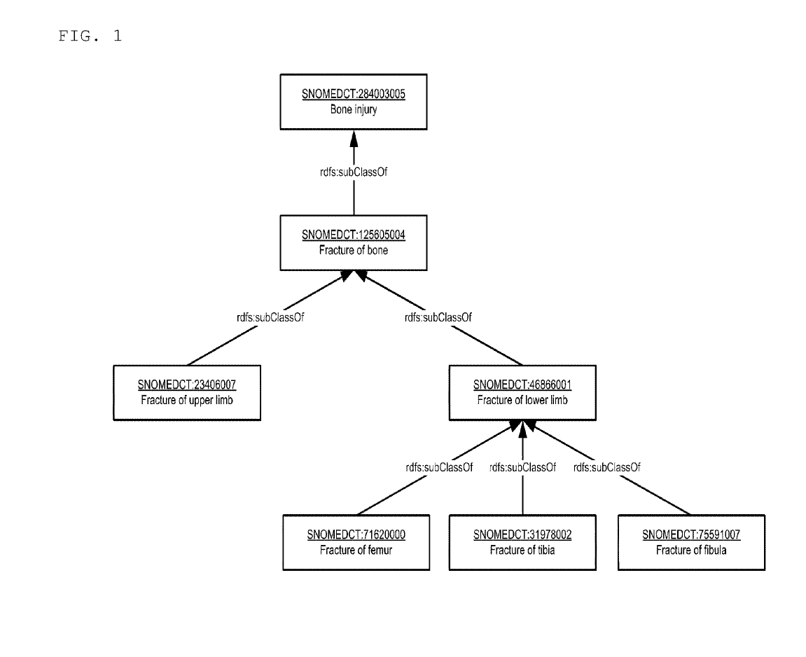

Consider an ontology describing bone fractures. The example shown in FIG. 1 is taken from SNOMED—CT which is a Systematized Nomenclature of Medicine Clinical Terms and has a class hierarchy.

The ontology schematically depicted in FIG. 1 is described as follows:
sct:FractureOfFemur rdfs:subClassOf sct:FractureOfLowerLimb.
sct:FractureOfFibula rdfs:subClassOf sct:FractureOfLowerLimb.
sct:FractureOfTibia rdfs:subClassOf sct:FractureOfLowerLimb.
sct:FractureOfLowerLimb rdfs:subClassOf sct:FractureOfBone.
sct:FractureOfUpperLimb rdfs:subClassOf sct:FractureOfBone.
sct:FractureOfBone rdfs:subClassOf sct:BoneInjury.

The following instance data are considered:

A patient with a hip fracture (i.e. a fracture of the “femur” or thigh bone).
:patient :hasCondition :condition.
:condition a sct:FractureOfFemur.

When we query for patients with “bone injuries”, the patient with the femoral fracture should be returned.

Four possible cases are compared in the explanation below.

The third case is the case according to the present invention, cases 1, 2 and 4 are described for comparative reasons.

### Case 1: No Materialization/Specialization (Comparative Embodiment)

In this case no materialisation, nor specialisation is performed on the rule sct.

The rules contain variables which quantify over properties (e.g. “?p”) and classes (“?C”).

At query time a reasoner reads the rules, the ontology and the instance data and produces the result. The reasoner has to calculate a (possibly huge) sct of statements containing the closure of the transitive properties. In this case this calculation is done each time a new query needs to answered.

### Rules

{ ?C rdfs:subClassOf ?D. ?x a ?C }=>{ ?x a ?D }.
{ ?p a owl:TransitiveProperty. ?x ?p ?y. ?y ?p ?z }=>{ ?x ?p ?z }.

### Ontology

rdfs:subClassOf a owl:TransitiveProperty.
sct:FractureOfFemur rdfs:subClassOf sct:FractureOfLowerLimb.
sct:FractureOfFibula rdfs:subClassOf sct:FractureOfLowerLimb.
sct:FractureOfTibia rdfs:subClassOf sct:FractureOfLowerLimb.
sct: FractureOfLowerLimb rdfs:subClassOf sct: FractureOfBone.
sct:FractureOfUpperLimb rdfs:subClassOf sct:FractureOfBone.
sct:FractureOfBone rdfs:subClassOf sct:BoneInjury.

### Result

sct:FractureOfFemur rdfs:subClassOf sct:FractureOfLowerLimb.
sct:FractureOfFemur rdfs:subClassOf sct:FractureOfBone,
sct:FractureOfFemur rdfs:subClassOf sct:BoneInjury.
sct:FractureOfFibula rdfs:subClassOf sct:FractureOfLowerLimb.
sct:FractureOfFibula rdfs:subClassOf sct:FractureOfBone.
sct:FractureOfFibula rdfs:subClassOf sct:BoneInjury.
sct:FractureOfTibia rdfs:subClassOf sct:FractureOfLowerLimb.
sct:FractureOfTibia rdfs:subClassOf sct:FractureOfBone.
sct:FractureOfTibia rdfs:subClassOf sct:BoneInjury.
sct:FractureOfLowerLimb rdfs:subClassOf sct:FractureOfBone.
sct:FractureOfLowerLimb rdfs:subClassOf sct:BoneInjury.
sct:FractureOfUpperLimb rdfs:subClassOf sct:FractureOfBone.
sct:FractureOfUpperLimb rdfs:subClassOf sct:BoneInjury.
sct:FractureOfBone rdfs:subClassOf sct:BoneInjury.
:patient :hasCondition :condition.
:condition a sct:FractureOfFemur.
:condition a sct:FractureOfLowerLimb.
:condition a sct:FractureOfBone.
:condition a sct:BoneInjury.

### Case 2: Properties Specialization (Comparative Embodiment)

In this case rules are eliminated using the specialization procedure explained, if in the resulting specialized rule, the variables no longer quantify over properties. This is done (manually) at development/deployment time.

At query time the reasoner reads the rules, the ontology and the instance data and produces the result.

This is state of the art technology.

In this state of the art method the number of rules is small, but if the ontology and rules make use of transitive properties, the reasoner has to calculate a (possibly huge) sct of statements containing the closure of the transitive properties.

This calculation is done each time a new query needs to answered.

### Rules

{ ?c: rdfs:subClassOf ?D. ?x a ?C } => { ?x a ?D }.
{ ?x rdfs:subClassOf ?y. ?y rdfs:subClassOf ?z } => { ?x rdfs:subClassOf ?z }.

### Ontology

sct: FractureOfFemur rdfs:subClassOf sct:FractureOfLowerLimb
sct:FractureOfFibula rdfs:subClassOf sct:FractureOfLowerLimb.
sct:FractureOfTibia rdfs:subClassOf sct:FractureOfLowerLimb.
sct:FractureOfLowerLimb rdfs:subClassOf sct:FractureOfBone.
sct:FractureOfUpperLimb rdfs:subClassOf sct:FractureOfBone.
sct:FractureOfBone rdfs:subClassOf sct:BoneInjury.

### Result

sct:FractureOfFemur rdfs:subClassOf sct:FractureOfLowerLimb.
sct: FractureOfFemur rdfs:subClassOf sct: FractureOfBone.
sct: FractureOfFemur rdfs:subClassOf sct: BoneInjury.
sct:FractureOfFibula rdfs:subClassOf sct:FractureOfBone.
sct:FractureOfFibula rdfs:subClassOf sct:BoneInjury.
sct:FractureOfTibia rdfs:subClassOf sct:FractureOfLowerLimb.
sct:FractureOfTibia rdfs:subClassOf sct:FractureOfBone.
sct:FractureOfTibia rdfs:subClassOf sct:BoneInjury.
sct:FractureOfLowerLimb rdfs:subClassOf sct:FractureOfBone.
sct:FractureOfLowerLimb rdfs:subClassOf sct:BoneInjury.
sct:FractureOfUpperLimb rdfs:subClassOf sct:FractureOfBone.
sct:FractureOfUpperLimb rdfs:subClassOf sct:BoneInjury.
sct:FractureOfBone rdfs:subClassOf sct:BoneInjury.
:patient :hasCondition :condition.
:condition a sct:FractureOfFemur.
:condition a sct:FractureOfLowerLimb.
:condition a sct:FractureOfBone.
:condition a sct:BoneInjury.

This state of the art method wherein the transitive closures are calculated at query time by applying rules on the knowledge sct and the data set at query time, may result in an unacceptable long query time.

### Case 3 Classes Specialization According To The Present Invention

In this case rules are eliminated using the specialization procedure explained above, if in the resulting specialized rule, the variables no longer quantify over classes.

This is done by an extra reasoning step that has to be done only once (or when the ontology changes, which is infrequently) at development/deployment time.

### Example

We can specialize rule
{ ?C rdfs:subClassOf ?D. ?x a ?C } => { ?x a ?D }.

with statement
sct:FractureOfFemur rdfs:subClassOf sct:FractureOfLowerLimb.

In this case P is “rdfs:subClassOf”, Q and C are “a” which is a short notation for “rdf:type”, so we get (variables x,y,z are renamed to C,D,x)
∀C, D, x : subClassOf(C,D) [symbol] type(x,C) [symbol] type(x,D)
subClassOf (FractureOfFemur, FractureOfLowerLimb)
Unifying C with FractureOfFemur and D with FractureOfLowerLimb the reasoner derives the specialized rule
∀x : type (x, FractureOfFemur) [symbol] type (x, FractureOfLowerLimb)
or in N3 format:
{ ?x a sct:FractureOfFemur } => { ?x a sct:FractureOfLowerLimb }.

Doing this for all “rdfs:subClassOf” statements in the ontology will generate all the rules below.

The set of rules is large, but the size of the set is linear with the number of statements in the ontology.

At query time the reasoner reads the rules, the instance data and produces the result. The advantage of this method of the present invention is that transitive closure does not need to be calculated, giving huge performance gains.

### Rules

{ ?x a sct:FractureOfFemur } => { ?x a sct:FractureOfLowerLimb }.
{ ?x a sct:FractureOfFibula } => { ?x a sct:FractureOfLowerLimb }.
{ ?x a sct:FractureOfTibia } => { ?x a sct:FractureOfLowerLimb }.
{ ?x a sct:FractureOfLowerLimb } => { ?x a sct:FractureOfBone }.
{ ?x a sct:FractureOfUpperLimb } => { ?x a sct:FractureOfBone }.
{ ?x a sct:FractureOfBone } => { ?x a sct:BoneInjury }.

### Result

:patient :hasCondition :condition.
:condition a sct:FractureOfFemur.
:condition a sct:FractureOfLowerLimb.
:condition a sct:FractureOfBone.
:condition a sct:BoneInjury.

The method of the present invention as described higher applies rule specialisation on the knowledge sct resulting in a specialised rule sct that can be generated in advanced and used at query time. The specialisation method avoids calculating transitive closures and is computationally less expensive. The generated rule sct is re-usable and the size of the rule sct is reasonable.

### Case 4 Transitive Closure Materialized

In this state of the art case which is explained below for comparative purposes only, the ontology is expanded using the materialization procedure explained above. This is done by an extra reasoning step that has to be done only once (or when the ontology changes, which is infrequently) at development/deployment time.

The set of statements in the ontology can become large, and contains the closure of the transitive properties.

The number of statements is quadratic with the number of original statements in the ontology using transitive properties.

E.g. The SNOMED-CT medical terminology, contains around 311000 concepts, in a hierarchy described with 435000 rdfs:subClassOf relations. The transitive closure consists of around 5285000 rdfs:subClassOf relations.

The size can become too large for a reasoner to calculate the materialized ontology (memory and/or calculation time limitations)

At query time the reasoner reads the rules, the ontology and the instance data and produces the result. The transitive closure does not need to be calculated, giving huge performance gains. However, the time spend on reading the large ontology cancels this benefit.

### Rules

{ ?C rdfs:subClassOf ?D. ?x a ?C } => { ?x a ?D }.

### Ontology

sct:FractureOfFemur rdfs:subClassOf sct:FractureOfLowerLimb.
sct:FractureOfFemur rdfs:subClassOf sct:FractureOfBone.
sct:FractureOfFemur rdfs:subClassOf sct:BoneInjury.
sct:FractureOfFibula rdfs:subClassOf sct:FractureOfLowerLimb.
sct:FractureOfFibula rdfs:subClassOf sct:FractureOfBone.
sct:FractureOfFibula rdfs:subClassOf sct:BoneInjury.
sct: FractureOfTibia rdfs:subClassOf sct: FractureOfLowerLimb.
sct:FractureOfTibia rdfs:subClassOf sct:FractureOfBone.
sct:FractureOfTibia rdfs:subClassOf sct:BoneInjury.
sct:FractureOfLowerLimb rdfs:subClassOf sct:FractureOfBone.
sct:FractureOfLowerLimb rdfs:subClassOf sct:BoneInjury.
sct:FractureOfUpperLimb rdfs:subClassOf sct:FractureOfBone,
sct:FractureOfUpperLimb rdfs:subClassOf sct:BoneInjury.
sct:FractureOfBone rdfs:subClassOf sct:BoneInjury.
:patient :hasCondition :condition.
:condition a sct:FractureOfFemur.
:condition a sct:FractureOfLowerLimb.
:condition a sct:FractureOfBone.
:condition a sct:BoneInjury.

This comparative method thus applies materialization on the rule sct. Transitive closures are calculated. Extended knowledge is generated by addition of these transitive closures. The extended knowledge sct is used at query time. Additional interpretation rules might be required at query time. The extended knowledge is reusable but its size is large due to the explicit statements that are created on the transitive closures.

1-4. (canceled)

5: A computer-implemented method of answering a query in a data repository, the method comprising the steps of:
generating a sct of specific reasoning rules for rule-based reasoning from a sct of generic reasoning rules by substituting at least one of the generic reasoning rules including more than one variable, at least one of the variables including at least one class defined in an ontology, and
applying the specific reasoning rules to the data repository to answer the query.

6: The method according to claim 5, wherein the generated set of specific reasoning rules are compiled into an image and stored; and
at a time of the query, a reasoner reads the generated set of specific reasoning rules and applies the generated set of specific reasoning rules to instance data to answer the query.

7: The method according to claim 5, wherein the data repository is a repository of clinical patient information.

8: A non-transitory computer readable medium including a computer program for carrying out the method according to claim 5 when the computer program is run on a computer.
